(19) United States
(12) Patent Application Publication
(10) Pub. No.: US 2005/0080500 A1
(43) Pub. Date: Apr. 14, 2005

(54) Audio device and playback method in audio device

(76) Inventor: Masaru Kimura, Iwaki-city (JP)

Correspondence Address: BRINKS HOFER GILSON & LIONE, P.O. BOX 10395, CHICAGO, IL, 60610, US

(21) Appl. No.: 10/936,216

(22) Filed: Sep. 8, 2004

(30) Foreign Application Priority Data
Sep. 10, 2003 (JP) 2003-317837

(51) Int. Cl. G06F 17/00

(52) U.S. Cl. 700/94; 381/104

(57) ABSTRACT

An audio device includes a DVD player for decoding an input audio signal and for outputting a digital audio signal, an audio amplifier for outputting an analog audio signal based on the digital audio signal, an audio decoder for detecting a change of an audio attribute, a decoding suspension unit for muting an output from the audio amplifier and temporarily suspending an operation of the decoder when the change of the attribute is detected, and a setting changing unit for changing operation conditions of the audio amplifier so as to correspond to the changed audio attribute when a muting part operates.

### BACKGROUND OF THE INVENTION

1. Field of the Invention

The present invention relates to audio devices for outputting audio signals for driving a speaker or the like. More specifically, it relates to an audio device capable of adapting to changes of audio attributes of content data read from a recording medium.

2. Description of the Related Art

FIG. 5 is a block diagram schematically showing the structure of a known audio device 100. Referring to FIG. 5, the audio device 100 includes a DVD player 110, an audio amplifier 120, and a system control central processing unit (CPU) 130. The DVD player 110 plays back digital data recorded on a digital versatile disk (DVD). The audio amplifier 120 receives an audio signal D1 sent from the DVD player 110. After performing digital-to-analog (D/A) conversion and the like on the audio signal D1, the audio amplifier 120 outputs an analog audio signal A2. The system control CPU 130 controls the DVD player 110 and the audio amplifier 120.

The digital audio signal D1 is output from a digital port of the DVD player 110. The digital audio signal D1 is transferred to the audio amplifier 120 via transfer cable, such as IEEE1394 or Sony Philips Digital Interface Format (SPDIF). Also, a digital-to-analog conversion (DAC) audio signal A1 is output from an analog port of the DVD player 110. The DAC audio signal A1 is converted into a digital signal via, for example, a digital transmission module 140 to be digitally transferred. The digital signal is converted into an analog signal again by a digital reception module 150 and is input to the audio amplifier 120. The audio amplifier 120 includes a digital signal processor (DSP) and an audio processor for performing processing corresponding to the attributes of an audio signal to be played back and generates an analog audio output A2 for driving a speaker.

For DVD-Videos and DVD-Audios played back by the DVD player 110, an attribute of an audio stream may change due to a change of a title or a track, sound switching, or the like. For example, an attribute, such as a sampling frequency (fs), the number of quantization bits (Qb), a compression format (Dolby or DTS), or the number of channels, is changed. When such an audio attribute changes, setting of the audio amplifier 120 must be changed accordingly.

When a change of an audio attribute of a digital audio output occurs, this change is detected by decoding the input digital audio signal by the audio amplifier 120. When the change of the audio attribute is detected, setting of a program and the like for the DSP and the like of the audio amplifier 120 is changed in accordance with the detection result. For example, in accordance with the number of channels of original content, processing of an audio DSP (for example, a Rear Fill function or a Bi-Phantom function) is switched on or off or in accordance with the audio format of the original content, a Pro Logic function or the like is switched on or off.

In contrast, for an analog audio output, the DVD player 110 changes setting of a digital-to-analog converter (DAC) provided therein and switches a clock to adjust timing. The DVD player 110 outputs a control signal S1 indicating a change of an audio attribute to the system control CPU 130. The system control CPU 130 outputs a control signal S2 instructing the audio amplifier 120 to change the audio attribute.

For changes of audio attributes, for example, a method for high-quality sound playback without interruption when a sampling frequency of transmission data changes during transmission is disclosed in Japanese Unexamined Patent Application Publication No. 2002-344561. When the sampling frequency of the transmission data changes during transmission, a receiver (amplifier) detects the change. In accordance with a detection result, suspension of reading or writing of data from or into a buffer of the receiver, switching of a reference clock frequency, restart of reading or writing of the data from or into the buffer of the receiver, and the like are controlled. Accordingly, high-quality sound playback without interruption can be performed.

However, the known audio device has the problems described below. The DVD player 110 continues playback operation without pause even if, for example, the number of channels or a format changes near a track border. The audio amplifier 120 can know a change of an audio attribute after decoding a digital audio signal. Thus, in order to change the internal setting, a predetermined time, such as hundreds of milliseconds, is needed. As a result of this, the audio amplifier 120 cannot process, in accordance with the setting corresponding to the change, an initial part of an audio signal having the changed audio attribute. Thus, the initial part cannot be successfully played back.

In contrast, even for an analog audio output, the changed number of channels or a changed format is reported after a request for information is sent from the system control CPU 130. The system control CPU 130 reports the change of the audio attribute to the audio amplifier 120 after hundreds of milliseconds. Then, hundreds of milliseconds are needed for the audio amplifier 120 to change the setting. After changing the setting, sound is output.

FIGS. 6(a) and 6(b) show changes of audio attributes when a track #n in which the number of channels is two and a format is linear pulse code modulation (LPCM) is changed to a track #n+1 in which the number of channels is six and a format is Meridian lossless packing (MLP). According to known specifications, at a point in time when the audio attributes change, in other words, when entering the track #n+1 in which the number of channels and the format change, the audio amplifier 120 performs playback based on setting information before the change (2ch, LPCM) during a predetermined time (T1) from the point in time when the audio attributes change. After muting is performed for hundreds of milliseconds as a time (T2) for changing the setting, sound is played back based on the changed setting information (6ch, MLP). Thus, in the track #n+1, a trouble occurrence time T3 (T1+T2) occurs, in other words, deterioration in the playback quality or playback failure occurs in an initial part.

### SUMMARY OF THE INVENTION

In order to solve the above problems, it is an object of the present invention to provide an audio device capable of appropriately playing back an audio signal in accordance with a change of an audio attribute and a playback method in the audio device.

An audio device according to an aspect of the present invention includes a playback unit for decoding an input audio signal and for outputting a digital audio signal; an audio output unit for outputting an analog audio signal based on the digital audio signal from the playback unit; a detection unit for detecting a change of an audio attribute of the input audio signal; a muting unit for muting the analog audio signal output from the audio output unit in accordance with detection of the change of the audio attribute by the detection unit; a decoding suspension unit for suspending decoding processing by the playback unit in accordance with the detection of the change of the audio attribute; and a setting changing unit for changing operation conditions of the audio output unit so as to correspond to a changed audio attribute during operation of the muting unit.

Preferably, the audio device further includes a muting release unit for releasing muting by the muting unit; and a decoding restart unit for restarting, after releasing muting, to decode the input audio signal having the changed audio attribute.

An audio device according to another aspect of the present invention includes a playback unit for decoding an input audio signal and for outputting a digital audio signal; an audio output unit for outputting an analog audio signal based on the digital audio signal from the playback unit; a decoding suspension unit for suspending decoding processing by the playback unit when a change of an audio attribute of the input audio signal occurs; a setting changing unit for changing operation setting of the audio output unit so as to correspond to a changed audio attribute; and a decoding restart unit for restarting the suspended decoding processing after changing the operation setting of the audio output unit and for decoding the input audio signal having the changed audio attribute.

Preferably, the playback unit is controlled to search for a track of an audio signal having the changed audio attribute.

A playback method according to the present invention in an audio device including a playback unit for decoding an input audio signal and for outputting a digital audio signal and an audio output unit for outputting an analog audio signal based on the digital audio signal from the playback unit includes the steps of detecting a change of an audio attribute of the input audio signal; muting the analog audio signal output from the audio output unit when the change of the audio attribute is detected; and changing an operation setting of the audio output unit so as to correspond to a changed audio attribute during the muting operation.

According to the present invention, when a change of an audio attribute is detected, decoding processing by the playback unit is temporarily suspended and an output of the audio output unit is muted. During this time, an operation setting of the audio output unit is changed so as to correspond to a changed audio attribute. Thus, the input audio signal having the changed audio attribute can be played back from the beginning without interruption.

### BRIEF DESCRIPTION OF THE DRAWINGS

FIG. 1 is a block diagram showing the main internal structure of a DVD player according to the present invention;

FIG. 2 is a flowchart showing a process performed when an audio attribute changes in a first embodiment of the present invention;

FIG. 3 illustrates a processing sequence of each unit in the first embodiment;

FIG. 4 illustrates a processing sequence of each unit in a second embodiment;

FIG. 5 shows an example of the structure of a known audio device; and

FIG. 6 explains known problems in changing an audio attribute.

### DESCRIPTION OF THE PREFERRED EMBODIMENTS

Embodiments of the present invention will be described with reference to the drawings. Preferably, for an audio device according to the present invention, a unit for producing an audio signal is a digital versatile disk (DVD) player and a unit for receiving the audio signal is an audio amplifier.

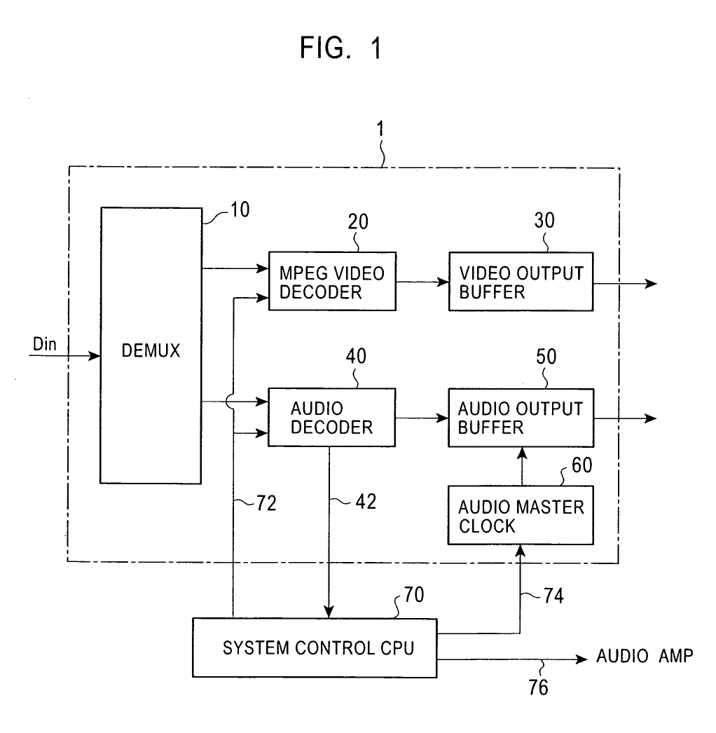

FIG. 1 is a block diagram showing the internal structure of a DVD player 1 according to the present invention. The DVD player 1 includes a demultiplexer (DEMUX) 10, an MPEG video decoder 20, a video output buffer 30, an audio decoder 40, an audio output buffer 50, and an audio master clock 60. The DEMUX 10 receives a bit stream Din read from a DVD, and separates the bit stream Din into a video signal and an audio signal. The MPEG video decoder 20 receives the video signal from the DEMUX 10, and decodes (expands) the MPEG-compressed video signal. The video output buffer 30 stores decoded video signals for some fields or for some frames, and outputs the decoded video signals. The audio decoder 40 receives the audio signal from the DEMUX 10, and decodes the audio signal. The audio output buffer 50 stores decoded audio signals, and outputs the audio signals in synchronization with reference clock signals from the audio master clock 60. The audio master clock 60 outputs certain types of reference frequencies (for example, 44.1 KHz and 48 KHz) corresponding to a sampling frequency of content.

A system control CPU 70 is electrically connected to the DVD player 1 and an audio amplifier (not shown) so that data, a control signal, and the like are transferred between them. If an audio attribute of the input audio signal decoded by the audio decoder 40 is different from the previous attribute, the audio decoder 40 outputs a standby notification indicating a change of an attribute to the system control CPU 70 via a data line 42. The system control CPU 70 gives the MPEG video decoder 20 and the audio decoder 40, via a control line 72, instructions to suspend or restart decoding processing and to transfer data to the output buffers. Also, when an audio attribute changes, the system control CPU 70 gives, via a control line 74, an instruction to change the setting conditions for the audio master clock 60. Furthermore, the system control CPU 70 gives, via a control line 76, various instructions to the audio amplifier.

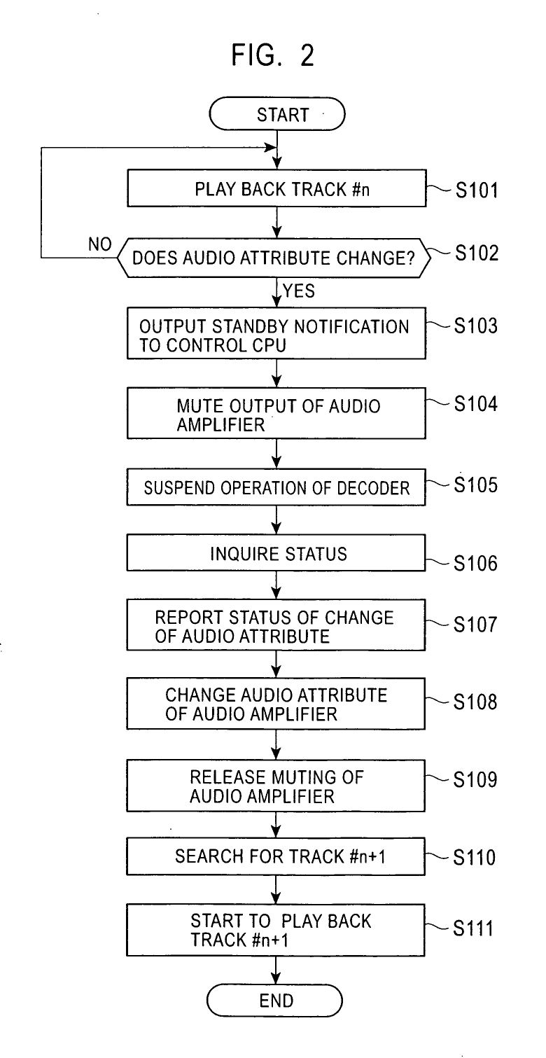

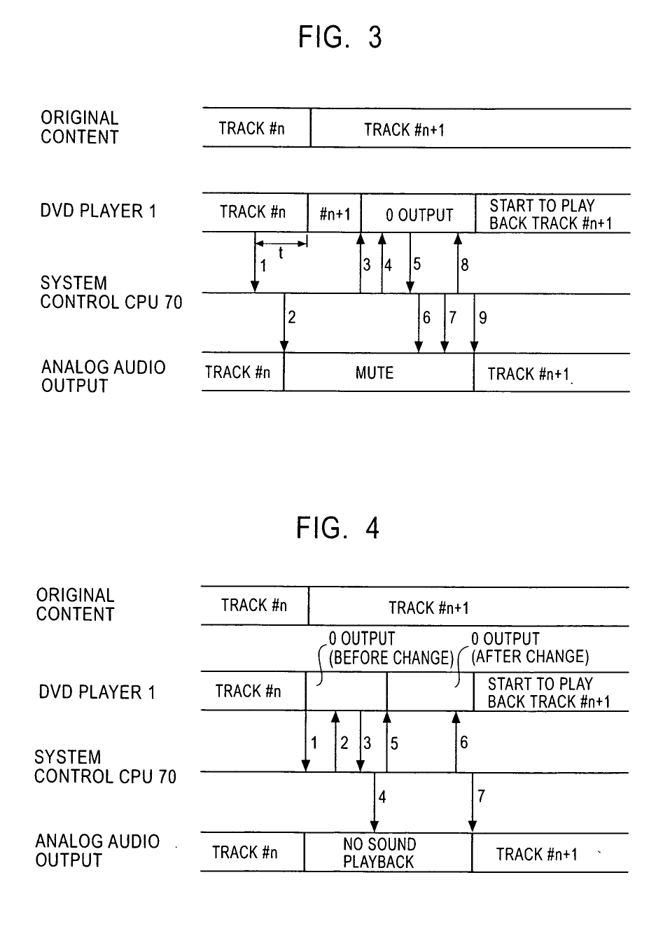

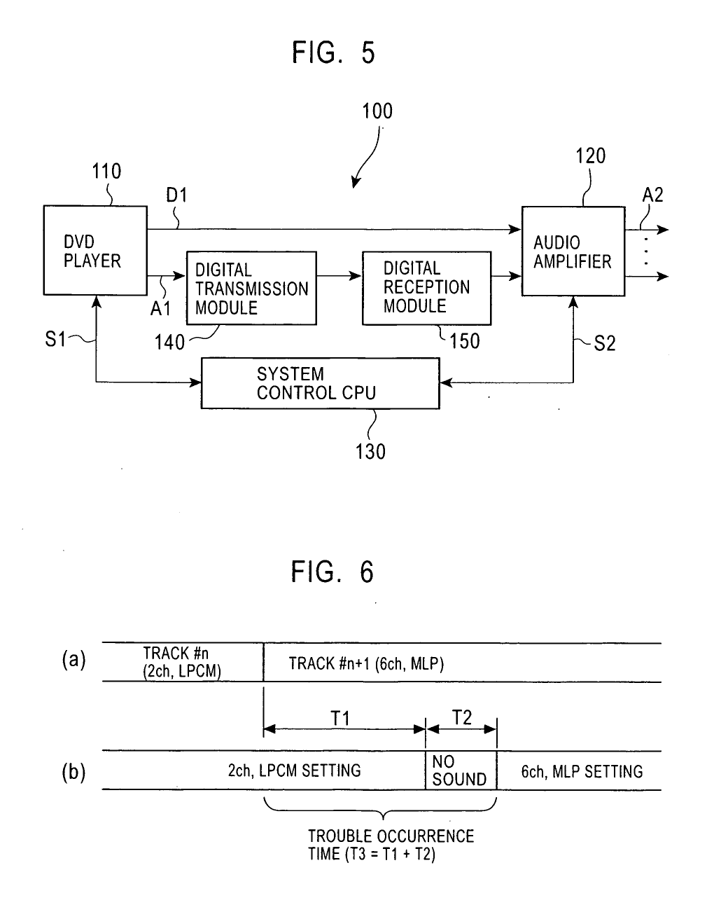

An operation performed when an audio attribute changes in the first embodiment will now be described with reference to a flowchart shown in FIG. 2 and an operation sequence of each unit shown in FIG. 3. As shown in FIG. 3, a track #n and a track #n+1 of original content have different audio attributes from each other. In transitioning from track #n to track #n+1, any one of audio attributes from among a sampling frequency fs, the number ch of channels, a format, and the like changes. Here, the number ch does not mean the total number of channels, such as 1ch or 6ch. The number ch means the arrangement of channels, such as left front (Lf), right front (Rf), center (c), low frequency effect (LFE), left surround (Ls), and right surround (Rs). An audio attribute does not always change in transitioning between tracks when playback is sequentially performed. An audio attribute may change when a track on a disc is searched for or when playback of a disc starts.

In the DVD player 1, track #n is played back (step S101). A bit stream Din read from track #n is separated into a video signal and an audio signal by the DEMUX 10. The video signal is decoded by the MPEG video decoder 20. Then, the decoded video signal is stored in the video output buffer 30, and is output at a predetermined read speed. In contrast, the audio signal is decoded by the audio decoder 40. Then, the decoded audio signal is output from the audio output buffer 50 in synchronization with a master clock.

In transitioning from track #n to track #n+1, the audio decoder 40 determines, on the basis of the decoding result, whether or not an audio attribute changes (step S102). If the audio decoder 40 detects a change of an audio attribute, the audio decoder 40 outputs a standby notification indicating the change of the audio attribute to the system control CPU 70 via the data line 42 (step S103, arrow 1 in FIG. 3). When the standby notification is output, part of the audio signal of track #n is still stored in the audio output buffer 50 arranged downstream. Thus, in fact, the standby notification is output 5 to 10 milliseconds (a time t) before termination of track #n.

When receiving the standby notification, the system control CPU 70 gives the audio amplifier an instruction to mute an audio output (step S104, arrow 2 of FIG. 3). In accordance with this instruction, the audio amplifier mutes the analog output. Thus, a last part of track #n is muted. Furthermore, the system control CPU 70 gives the audio decoder 40 and the MPEG video decoder 20 an instruction to temporarily suspend decoding processing via the control line 72 (step S105, arrow 3 in FIG. 3). Although the audio decoder 40 and the MPEG video decoder 20 have already decoded part of track #n+1 by the time the instruction is given, the decoding processing is suspended at this point. Thus, no video output or audio output is generated from the DVD player 1.

In order to know the audio attributes of track #n+1, the system control CPU 70 outputs a status inquiry via the control line 72 (step S106, arrow 4 in FIG. 3). In response to the inquiry, the DVD player 1 sends the audio attributes of track #n+1 to the system control CPU 70 (step S1107, arrow 5 in FIG. 3). Based on the received audio attributes, the system control CPU 70 outputs, via the control line 76, an instruction to change the setting of the audio amplifier (step S108, arrow 6 in FIG. 3). In accordance with the instruction, the audio amplifier changes the operation setting. After changing the setting, the system control CPU 70 gives the audio amplifier an instruction to release muting (step S109, arrow 7 in FIG. 3).

Based on the status received from the DVD player 1, the system control CPU 70 sends a search command or a menu calling command for track #n+1, and gives the MPEG video decoder 20 and the audio decoder 40 an instruction to restart the decoding processing (step S110, arrow 8 in FIG. 3).

The audio decoder 40 and the MPEG video decoder 20 start to decode track #n+1 from the beginning, and the audio amplifier generates an analog audio output from the beginning of track #n+1 without interruption under the setting conditions corresponding to the audio attributes of track #n+1 (step S111, arrow 9 in FIG. 3). Consequently, the analog audio output can be played back such that sound is synchronized with the start of an image.

For example, when the sampling frequency fs is changed from 48 KHz to 96 KHz in the transition from track #n to track #n+1, in accordance with the change of attribute detected by the audio decoder 40, the audio master clock 60 is switched to output a reference clock of 96 KHz. However, an output of the audio amplifier is muted and the audio decoder 40 and the MPEG video decoder 20 of the DVD player 1 are temporarily suspended. Thus, during this time, the setting conditions (in this case, the sampling frequency) of the audio amplifier are changed. After changing the setting conditions of the audio amplifier, decoding processing is started from the beginning of the audio signal of track #n+1, and the decoded digital audio signal is output to the audio amplifier. The audio amplifier generates a predetermined analog audio output for driving a speaker.

As described above, although, as shown in FIG. 3, an analog audio output of a last part (5 to 10 milliseconds) of track #n is not generated due to muting by the audio amplifier, track #n+1 can be played back from the beginning under the operation conditions corresponding to the changed audio attribute.

A second embodiment of the present invention will now be described. FIG. 4 shows a processing sequence of each unit when an audio attribute changes in the second embodiment. In the first embodiment, since a standby notification indicating a change of an audio attribute is output substantially 5 to 10 milliseconds before termination of track #n and the audio amplifier is muted, part of track #n is not played back. Also, in the first embodiment, during tens of milliseconds until the DVD player 1 performs standby execution, part of track #n+1 is decoded by the MPEG video decoder 20 and the audio decoder 40 and playback of an image is advanced. In the second embodiment, the first embodiment is improved in the points described above.

In the second embodiment, as shown in FIG. 4, when an audio attribute changes, a standby notification from the DVD player 1 is output at the same time as termination of track #n (arrow 1 in FIG. 4). In other words, unlike the first embodiment, a time from decoding of an audio signal of track #n+1 to outputting of a standby notification is delayed by about 5 to 10 milliseconds (the time t in FIG. 3). Alternatively, apart from this, a data accumulation time of the audio output buffer 50 may be reduced by the time t. When the audio decoder 40 decodes the audio signal of track #n+1 and when the MPEG video decoder 20 decodes the video signal of track #n+1, each of the audio decoder 40 and the MPEG video decoder 20 automatically suspends the decoding processing. Thus, no output is generated from the audio decoder 40, and the MPEG video decoder 20 outputs the last frame of track #n. As a result of this, a still image is displayed on a display.

Unlike the first embodiment, the system control CPU 70 inquires about status without muting the audio amplifier (arrow 2 in FIG. 4). The audio decoder 40 sends the status of the audio attributes of track #n+1 to the system control CPU 70 (arrow 3 in FIG. 4). In accordance with the received status, the system control CPU 70 changes the setting operation of the audio amplifier so as to correspond to the attributes of track #n+1 (arrow 4 in FIG. 4).

The system control CPU 70 outputs a notification for permitting a change of the audio attribute (arrow 5 in FIG. 4). Part of the notification is output to the audio master clock 60 via the control line 74 so that the output conditions of the audio signal are reset. For example, when the sampling frequency fs changes, a clock frequency of the audio master clock 60 is switched at this point in time.

The system control CPU 70 searches for track #n+1 and gives an instruction to start to play back track #n+1 (arrow 6 in FIG. 4). In accordance with the instruction, the MPEG video decoder 20 and the audio decoder 40 start to decode track #n+1. Since there is no output from the audio decoder 40 during this time, an analog audio output is not generated from the audio amplifier, thus performing no sound playback.

The MPEG video decoder 20 and the audio decoder 40 restart operation, and the audio amplifier generates an analog audio output in synchronization with a video output under the operation conditions corresponding to the audio attributes of track #n+1 (arrow 7 in FIG. 4).

According to the second embodiment, when an audio attribute changes, an ideal audio output can be achieved from the beginning of track #n+1 without losing sound playback of a last part of track #n and without decoding only an initial part of track #n+1 by decoders.

While the preferred embodiments of the present invention have been described, the present invention is not limited to each of the embodiments described above. Various changes and modifications may be made to the present invention without departing from the scope and spirit of the present invention as defined by the claims.

The present invention is applicable to an audio device for playing back a digital audio signal. The audio device may have a video playback function or have other functions in a complex fashion. Alternatively, the audio device may be combined with a function of a navigation device or the like, or may be an audio system including a plurality of devices.

1. An audio device comprising:
a playback unit for decoding an input audio signal and for outputting a digital audio signal;
an audio output unit for outputting an analog audio signal based on the digital audio signal from the playback unit;
a detection unit for detecting a change of an audio attribute of the input audio signal;
a muting unit for muting the analog audio signal output from the audio output unit in accordance with detection of the change of the audio attribute by the detection unit;
a decoding suspension unit for suspending decoding processing by the playback unit in accordance with the detection of the change of the audio attribute by the detection unit; and
a setting changing unit for changing an operation setting of the audio output unit so as to correspond to a changed audio attribute during operation of the muting unit.

2. The audio device according to claim 1, further comprising a muting release unit for releasing muting by the muting unit; and a decoding restart unit for starting, after releasing muting, to decode the input audio signal having the changed audio attribute.

3. The audio device according to claim 1, wherein:
the playback unit includes an output buffer for storing the decoded audio signal; and
the muting unit performs muting before the digital audio signal having an audio attribute before the change is output from the output buffer.

4. The audio device according to claim 1, further comprising a muting release unit for releasing muting by the muting unit; and a decoding restart unit for starting, after releasing muting, to decode the input audio signal having the changed audio attribute, wherein:
the playback unit includes an output buffer for storing the decoded audio signal; and
the muting unit performs muting before the digital audio signal having an audio attribute before the change is output from the output buffer.

5. The audio device according to claim 1, wherein the change of the audio attribute of the input audio signal is a change of the number of channels of the audio signal.

6. The audio device according to claim 1, wherein the change of the audio attribute of the input audio signal is a change of a sampling frequency of the audio signal.

7. An audio device comprising:
a playback unit for decoding an input audio signal and for outputting a digital audio signal;
an audio output unit for outputting an analog audio signal based on the digital audio signal from the playback unit;
a decoding suspension unit for suspending decoding processing by the playback unit when a change of an audio attribute of the input audio signal occurs;
a setting changing unit for changing an operation setting of the audio output unit so as to correspond to a changed audio attribute; and
a decoding restart unit for restarting the suspended decoding processing after changing the operation setting of the audio output unit and for decoding the input audio signal having the changed audio attribute.

8. The audio device according to claim 7, wherein the decoding restart unit starts the decoding processing from the beginning of the audio signal having the changed audio attribute.

9. The audio device according to claim 7, wherein:
the playback unit is capable of reading content data recorded on a recording medium; and
when the content data to be read changes, the audio attribute changes.

10. The audio device according to claim 7, wherein:
the playback unit includes a digital versatile disk playback device for playing back data recorded on a digital versatile disk; and
the audio output unit includes an audio amplifier.

11. The audio device according to claim 7, wherein:
the decoding restart unit starts the decoding processing from the beginning of the audio signal having the changed audio attribute;
the playback unit is capable of reading content data recorded on a recording medium; and
when the content data to be read changes, the audio attribute changes.

12. The audio device according to claim 7, wherein:
the decoding restart unit starts the decoding processing from the beginning of the audio signal having the changed audio attribute;
the playback unit includes a digital versatile disk playback device for playing back data recorded on a digital versatile disk; and
the audio output unit includes an audio amplifier.

13. The audio device according to claim 7, wherein:
the playback unit includes a digital versatile disk playback device for playing back data recorded on a digital versatile disk;
the audio output unit includes an audio amplifier;
the playback unit is capable of reading content data recorded on a recording medium; and
when the content data to be read changes, the audio attribute changes.

14. The audio device according to claim 7, wherein the change of the audio attribute of the input audio signal is a change of the number of channels of the audio signal.

15. The audio device according to claim 7, wherein the change of the audio attribute of the input audio signal is a change of a sampling frequency of the audio signal.

16. A playback method in an audio device including a playback unit for decoding an input audio signal and for outputting a digital audio signal and an audio output unit for outputting an analog audio signal based on the digital audio signal from the playback unit, the playback method comprising:
detecting a change of an audio attribute of the input audio signal;
muting the analog audio signal output from the audio output unit when the change of the audio attribute is detected; and
changing an operation setting of the audio output unit so as to correspond to a changed audio attribute during muting operation.

17. The playback method according to claim 16, further comprising the act of suspending decoding processing by the playback unit during the muting operation and restarting the decoding processing by the playback unit after termination of the muting operation.

18. A playback method in an audio device including a playback unit for decoding an input audio signal and for outputting a digital audio signal and an audio output unit for outputting an analog audio signal based on the digital audio signal from the playback unit, the playback method comprising:
suspending decoding processing by the playback unit when a change of an audio attribute of the input audio signal occurs;
changing an operation setting of the audio output unit so as to correspond to a changed audio attribute; and
restarting the suspended decoding processing after changing the operation setting.

19. The playback method according to claim 18, wherein the change of the audio attribute of the input audio signal is a change of the number of channels of the audio signal.

20. The playback method according to claim 18, wherein the change of the audio attribute of the input audio signal is a change of a sampling frequency of the audio signal.
